(19) United States
(12) Patent Application Publication
(10) Pub. No.: US 2005/0160206 A1
(43) Pub. Date: Jul. 21, 2005

(54) Method and system for calculating dynamic burst length

(75) Inventor: Kun-Ying Tsai, Hsin Chu (TW)

Correspondence Address: Mr. Steven M. Jensen;Mr. Peter F. Corless, EDWARDS & ANGELL, LLP, 101 Federal Street, Boston, MA, 02110, US

(73) Assignee: RDC SEMICONDUCTOR CO., LTD., Hsin Chu (TW)

(21) Appl. No.: 10/759,320

(22) Filed: Jan. 16, 2004

(51) Int. Cl. G06F 13/00

(52) U.S. Cl. 710/52

(57) ABSTRACT

A method and a system for calculating dynamic burst length are provided. A valid data calculating module determines if the number of valid data in the buffering memory unit exceeds a preset threshold for a main memory unit bus; if yes, a main memory unit bus requesting module determines whether the data length exceeds a preset length value in a main memory unit; if no, a main memory unit bus requesting module sends a usage request to the main memory unit. A data length calculating module determines if a sending data byte is the end of the data; if yes, length of the data byte is calculated. A burst length determining module compares the valid data byte length, the data length and a preset burst length, and selects the least one as the burst length value.

### FIELD OF THE INVENTION

The present invention relates to methods and systems for calculating dynamic burst length, and more particularly, to a method and system for calculation dynamic burst length to determine the reasonable value of data bytes read out from a buffer by calculating the data length in the buffer at real time.

### BACKGROUND OF THE INVENTION

Due to the continuous development of the electronic information related technology, many high-performance products with reasonable prices have emerged. Taking computer communication equipments as an example, the large-scale supercomputers, servers, personal computers and even laptop have become the essential channels and tools for information flow between people. In addition, there is a high improvement and growth in the hardware and software of the communication network nowadays compared to before, so many large enterprises and or businesses have turned their organizations into networks, for it be the Internet, Intranet or Extranet. Of course, those with two or three network communication systems are not among the least. Besides for the enterprises and businesses that turn their organizations into networks, for schools, homes, and even individuals, computer equipments and network communication system has long become the indispensable tools in transmitting or receiving information.

Once various computer equipments are employed to send and receive information via the network communication system, there has to be a fixed data transmitting protocol between the various information sending nodes, for example, between the terminal equipments or the servers. Taking the conventional Ethernet architecture as an example, the media access method is called Carrier Sense Multiple Access/Collision Detection (CSMA/CD), or IEEE 802.3 communication protocol. Generally speaking, before every node on the network wishes to send information, it has to detect, on the network cable, whether there is another node using the network (Carrier Sense). If the cable is idle, the node may send its data onto the cable, and continue to listen to the cable signals; since Ethernet is a broadcast media, there is no priority concept, so it is possible that more than two nodes are sending data to the cable at the same time (Multiple Access). If a plurality of nodes are sending at the same time, data collision occurs (Collision), the network node closest to the collision will detect this collision and send out a jamming signal, the colliding nodes then stop transmitting data. The colliding nodes wait a random amount of time before resending the data to avoid further collision. The waiting time for every node is randomly generated, the same frame can be sent repeatedly for 16 times, the node gives up if it still fails after that, and sends an error message to the upper protocol layer.

When data are transmitted in a network, they are transmitted as packets. In general, using the above communication protocol, data packet size is 64 to 1518 bytes, wherein the destination address and source address each has 7 bytes, length field has 2 bytes, data field has 46 to 1500 bytes and frame check sequence field has 4 bytes.

When each node on the network wishes to receive data packets transmitted from the network, the network interface card of the node determines whether the packets belong to the node; if so, these data packets are transformed from serial form to parallel form to be processed by the node. Since the bus of the main memory unit is a shared resource in the system, so when data is received, other system units may be occupying the main memory unit bus, therefore the data packets cannot be sent to the main memory unit immediately to be processed by the central processing unit, they are stored temporarily in a buffering memory unit, and they are sent out from the buffering memory unit and read into the main memory when the node gets the usage right to the main memory unit bus. According to the above, under normal circumstances, the number of bytes of the network data packet does not exceed 1518, but to reduce costs, the buffering memory unit size is usually smaller than 1518 bytes. If the data cannot be sent to the main memory unit in time before the buffering memory unit is filled up, data will be lost, and the size of network packets is not uniform, sizes from 64 bytes to 1518 bytes are possible. Thus one important task of data communication is how to calculate dynamically the length of the valid data in the buffering memory unit and the critical point between the network packets, in order to avoid mixing of different packets, and send the data to the main memory unit. Moreover, data sent onto the network often have collision as described above, resulting sometimes in abnormal packet length. Assuming a data with 2000 bytes, and the size of the preset packet storage of the main memory unit is smaller than 2000 bytes, then this data will not have meaning to the receiving end, i.e. the data is useless. Since the main memory unit bus is a shared resource in the whole system nodes, so the main memory unit bus resource should not be unnecessarily occupied to avoid reducing the data processing efficiency of the system. The forgoing problem similarly occurs in other systems that transfer data via the main memory bus, for example, in a conventional personal computer system, a bus is required to perform data sending and receiving tasks between I/O devices, memory units and CPU, therefore the problem related to how to increase the main memory unit bus usage efficiency is not simple.

Current conventional data processing system has not yet had an effective solution for the problem of resource wastage involved when main memory unit bus is used.

### SUMMARY OF THE INVENTION

In order to solve the problems presented in the prior art, An objective of the present invention is to provide a method and a system for calculating dynamic burst length to dynamically increase the data usage efficiency of a main memory unit bus used to transfer data within a data processing system at real-time.

Another objective of the present invention is to provide a method and a system for calculating dynamic burst length, which allow effective data in the buffering memory unit to be transferred to the main memory unit in time for the data processing system and dynamically prevent the decrease in system operation efficiency caused by length of data bytes exceeding the preset size of the main memory unit.

To achieve the above and other objectives, the dynamic burst length calculating system according to the present invention includes: a data transfer system connection module used to send/receive data for the data processing system; a buffering memory unit that is configured in advance to receive data sent from other data transfer systems; a valid data calculating module used to calculate the valid data amount temporarily stored in the buffering memory unit; a data length calculating module that calculates the byte length of the data waiting to be transferred; a main memory unit bus request module that determines whether the amount of valid data temporarily stored in the buffering memory unit and calculated by the valid data calculating module exceeds the preset value, and if so, a request of data transfer usage right is sent to the main memory unit bus; and a burst length determining module used to determine the length of burst data byte.

Through the above dynamic burst length calculating system, the steps of dynamic burst length calculation practically performed comprise: firstly, when a data byte is written into a buffering memory unit, a write-in index address is added by one; when a data byte is read out from the buffering memory unit, a read-out index address is added by one; then, the valid data calculating module determines if the number of valid data in the buffering memory unit exceeds a preset threshold for a main memory unit bus; if yes, then the main memory unit bus requesting module determines whether the data length exceeds a per-set length value in the main memory unit or not; if yes, the main memory unit bus request is no longer sent until the data transfer is over; if no, the main memory unit bus requesting module sends a usage request to the main memory unit; moreover, the data length calculating module determines if a sending data byte is the end of the data; if yes, length of the data byte is calculated; finally, the burst length determining module compares the valid data byte length, the data length and a preset burst length in the buffering bus requesting module, and selects the least one as the burst length value.

By using the above dynamic burst length calculating method and system, a dynamic and in-time data processing system for transferring data is provided to increase the main memory unit bus resource usage efficiency and to avoid abnormal system operations caused when the length of the data byte exceeds the size of the main memory capacity.

### BRIEF DESCRIPTION OF THE DRAWINGS

A better understanding of the present invention can be obtained when the forthcoming detailed description is considered in conjunction with the following drawings, in which:

FIG. 1 is a block diagram showing the basic structure of a dynamic burst length calculating system according to a preferred embodiment of the present invention;

FIG. 2 and FIG. 2B are schematic diagrams showing packet data received from a network communication system in a buffering memory unit; and

FIG. 3A and FIG. 3B are flowcharts showing the steps for a dynamic burst length calculating method according to the invention.

### DETAILED DESCRIPTION OF THE PREFFERED EMBODIMENT

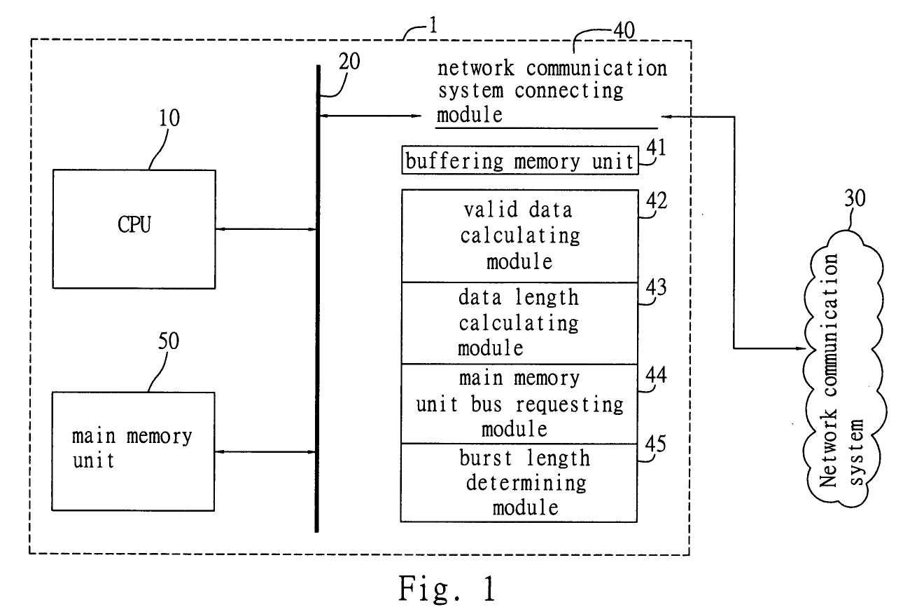

Please refer to FIG. 1, where the basic structure according to one embodiment of the dynamic burst length calculating system of the present invention applied to a network communication node is shown, wherein, the network communication node in the present embodiment is a compute device. Please note that this computer device further includes other functions, the embodiment below only described the part that are relevant to the present invention. The dynamic burst length calculating system includes the following components: a CPU (central processing unit) 10, a memory bus 20, a network communication system 30, a network communication system connecting module 40, and a main memory unit 50.

The CPU 10 provides the interoperability between the components of the dynamic burst length calculating system and the modules.

The main memory unit bus 20, in the present invention, is used to provide a hardware path for transferring data between the CPU 10 and the various memory units within the burst dynamic length calculating system 1; substantially, the main memory unit bus 20 is a shared high-speed passage between components of the same system organization (including the CPU 10, a disk control card memory and I/O connecting ports (not shown)) in the computer device, which also allows signals to be communicated within the same system organization.

Network communication system 30 means a group of computers and related equipments where the network components therein connect to each other. In the present invention, the network communication system 30 is an Ethernet system, wherein the standard for Ethernet system is IEEE 802.3 standard, established especially for Internet connection. Since Ethernet is a well-known Internet connecting system, so it will not be illustrated in details herein.

The network communication system connecting module 40 is used to send and receive data via the network communicating system 30 for the dynamic burst length calculating system 1. In the present invention, the network communication system connecting module 40 is a network interface card used to provide network data access for the computer device of the node. Briefly speaking, it determines if a packet belongs to the node, if yes, then these packet data is transformed from serial format to parallel format for processing use of the network node computer device, wherein the network communication system connecting module 40 comprises a buffering memory unit 41, a valid data calculating module 42, a data length calculating module 43, a main memory unit bus requesting module 44, and a burst length determining module 45.

The data accessing of buffering memory unit 41 is controlled by the network communication system connecting module 40, the buffering memory unit 41 is used to provide a specific area for keeping data waiting to be sent or received by the network communicating system 30.

The valid data calculating module 42 controlled by the network communication system connecting module 40 is used to calculate the amount of valid data stored temporarily in the buffering memory unit for the dynamic burst length calculating system 1.

The data length calculating module 43 controlled by the network communication system connecting module 40 is used to calculate the length of the packet data bytes waiting to be transferred for the dynamic burst length calculating system 1.

The main memory unit bus requesting module 44 controlled by the network communication system connecting module 40 is used to determine whether the amount of valid packet data temporarily stored in the buffering memory unit and calculated by the valid data calculating module exceeds the preset value or not for the dynamic burst length calculating system 1. In addition, the main memory unit bus requesting module 44 further determines whether the length of data packet exceeds the preset size for storing packets of the main memory unit 50. If yes, then the main memory bus request is no longer sent until this packet is over; if no, then a data transfer usage request is sent to the main memory unit bus.

The burst length determining module 45 controlled by the network communication system connecting module 40 is used to determine the length of burst data bytes of the dynamic burst length calculating system 1.

The main memory unit 50 is used to store data for the network communication nodes and interconnect to the CPU 10 in order to perform data operation processes. The main memory unit 50 in the present invention is a dynamic memory access memory (DRAM).

By using the forgoing dynamic burst length calculating system 1, the steps for performing the dynamic burst length calculation include the following:

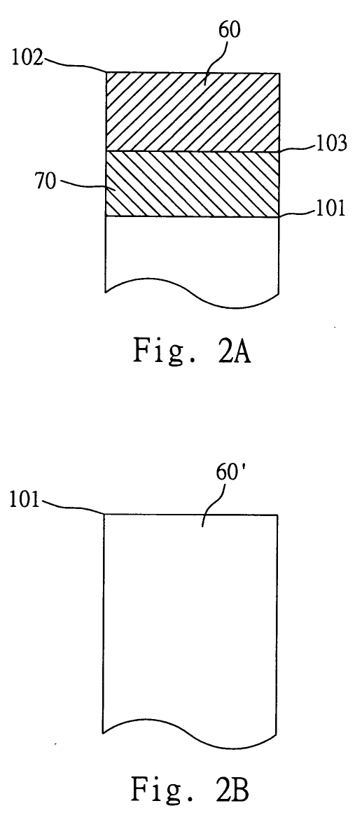

Please refer to FIG. 2A, showing the packet data received from the network communication system 30 in the buffering memory unit 41. Firstly, after data packets 60 and 70 are received successively by the network communicating system connection module 40 via the network communication system, and when the data byte is written into the buffering memory unit 1, the write-in index 101 address in a register is added by one. On the other hand, when a data byte is read out from the buffering memory unit 41, a read-out index 102 address is added by one.

Then, the valid data calculating module 42 determines whether the amount of valid packet data in the buffering memory unit 41 exceeds the preset main memory unit bus requesting threshold value or not. If yes, then the main memory unit bus requesting module 44 determines whether the data length exceeds a per-set size for storing packets of the main memory unit or not. If yes, the main memory unit bus request is no longer sent until the data transfer is over. This situation usually occurs when there is an abnormal data packet or when the size of main memory for storing packet data is too small. If no, the main memory unit bus requesting module 44 sends a main memory unit bus 20 usage request. The amount of the valid packet data is the number of bytes between the write-in index 101 and the read-out index 102. The main memory bus requesting threshold is set to 18 data bytes in the present invention, and the length f valid data bytes in the buffer is set to 20 bytes, so the memory bus requesting module 44 sends a main memory unit bus 20 usage request.

Moreover, the data length calculating module 43 determines if a sending data byte is the end of the data; if yes, a data end index 103 is written into the register, which allows the network communication system connecting module 40 makes sure that the end point of the data packets in order to write into the buffering memory unit 41. Through the addresses of the data end index 103 and the read-out index 104, the length of the current data packet byte. In this embodiment, this is the amount of data bytes of the data packet 60. Please refer to FIG. 2B, if the end of the sending data packet 60′ is not yet written into the buffering memory unit 41 within the buffer, then the data end index 103 address is set to infinitely faraway.

Finally, the burst length determining module 45 compares the valid data byte length, the packet data length and the preset burst length, and selects the least one as the burst length value. In the present invention, set the valid data byte length in the buffering memory unit to be 20 data bytes. The data end index 103 address is set to infinitely faraway as the data byte at the end of data packet 60′ has not yet been written into the buffering memory unit 41. The preset burst length is set to 30 data bytes. Therefore, he burst length determining module 45 determines the smallest value, i.e. 20 data bytes as the burst length value. On the other hand, when the data byte at the end of the data packet 60 is written into the buffering memory unit 41, then the length of the packet data byte can be calculated using the addresses of the data end index 103 and the read-out index 102. Then the packet data length of the data packet 60 is compared with the valid data byte length and the preset burst length in the buffering memory unit, and selects the least one as the burst length value, thereby avoiding a data packet 70 following the data packet 60 and having a memory unit address disconnected from the data packet 60 being connected to the data packet 60 and being written to the main memory unit of the node computer device via the main memory unit bus.

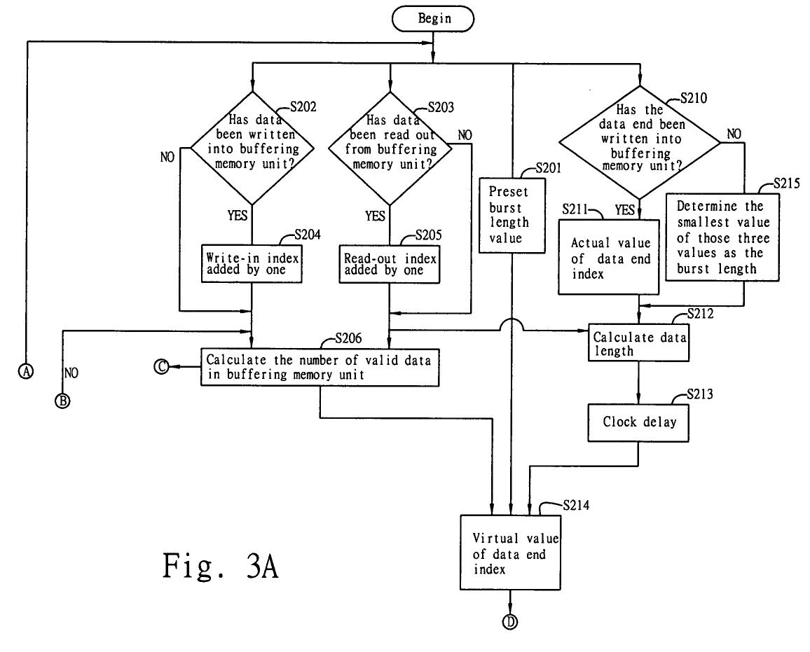

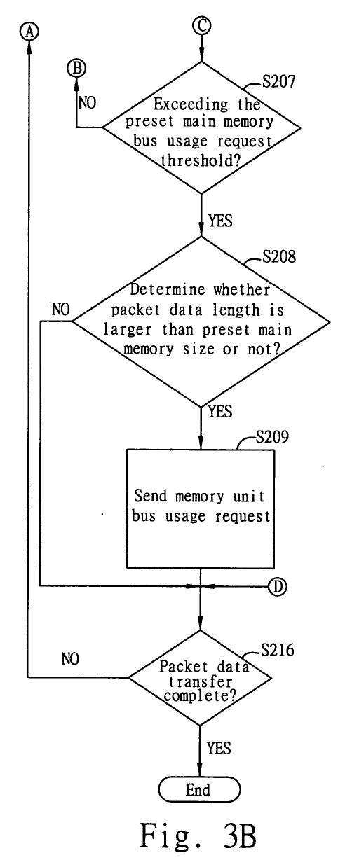

Referring to FIG. 3A and FIG. 3B showing a flowchart of the dynamic burst length calculating method and the steps when performing the dynamic burst length calculation.

In step S201, the burst length value is preset to be 30 data bytes.

In step S202, it is to determine whether a data packet byte is written into the buffering memory unit 41. If yes, perform step S204; if no, perform step S206.

In step S203, it is to determine whether a data packet byte is read out from the buffering memory unit 41. If yes, perform step S205; if no, perform step S206.

In step S204, the address of the write-in index 101 in a register is added by one, then performing step S206.

In step S205, the address of the read-out index 101 in a register is added by one, then performing step S206.

In step S206, the valid data calculating module 42 calculates the amount of valid packet data in the buffering memory unit 41, then performing step S207.

In step S207, the valid data calculating module 42 determines whether the amount of the valid packet data exceeds the preset main memory unit bus requesting threshold or not. If yes, then perform step S208; if no, return to step S206.

In step S208, the main memory unit bus requesting module 44 determines whether the packet length exceeds the preset size of packet storage in the main memory unit or not. If yes, then perform step S209; if no, perform step S216.

In step S209, the main memory unit bus requesting module 44 sends a usage request to the main memory unit bus 20, then performing step S216.

In step S210, the data length calculating module 42 determines whether the sending data byte is the end of the data packet. If yes, perform step S211; if no, perform step S215.

In step S211, the data end index 103 is written into the register to allow the network communication system connecting module 40 to decide the end point of the data packet for writing into the buffering memory unit 41 of the buffer, then performing step S212.

In step S212, the length of the current data packet bytes is calculated sing the addresses of the data end index 103 and the read-out index 102, then performing step S213.

In step S213, a clock delay is added to segment different data packet, then performing step S214.

In step S214, the burst length determining module 45 compares the valid data byte length, the packet data length and the preset burst length in the buffering memory unit 41, and selects the least one as the burst length value.

In step S215, the address of the data end index 103 is set to infinitely faraway.

In step S216, the burst length determining module 45 determines whether the data packet transfer has completed. If yes, end the process; if no, return to step S201 to restart the process.

According to the above, by using the dynamic burst length calculating method and system, when any data packet received by the network communication system connecting module 40 via the network communication system 30, and when the amount of data bytes of the data packet (assuming to be 2000 data bytes) is larger than the preset capacity of the buffering memory unit 41 (assuming to be 1518 data bytes), then the packet data is invalid since the data bytes thereof exceed the capacity of the buffering memory unit 41. At that time, the write-in index is paused until the address of the write-in index 101 is equal to the address of the read-out index. Since the address of the write-in index 101 is equal to the address of the read-out index, the burst length calculating system will not request the main memory unit bus 20 consenting any data sent from the network communication system connecting module 40, thereby no more meaningless packet data would be transferred by the main memory unit bus 20, which consequently eliminates the abnormal operations of the system of the node computer device.

The descriptions of the dynamic burst length calculating method and system above are only specific embodiments illustrating the present invention, they are not to limit the scope of the substantial techniques of the present invention. The substantial techniques of the dynamic burst length calculating method and system of the present invention are broadly defined in the claims below. Every details of this specification can be modified by others skilled in the art based on different viewpoints and applications yet still within the scope of the present invention if they are the same or equivalent to those defined in the claims.

1. A method for calculating dynamic burst length, for providing a data processing system through a dynamic burst length calculating system, so as to increase usage efficiency of a main memory unit bus and protect operation of the data processing system against effects from abnormal data, the dynamic burst length calculating system comprising a CPU (central processing unit) for providing interoperability between components and modules of the dynamic burst length calculating system, the main memory unit bus for transferring data between the CPU and a plurality of memory units of the burst dynamic length calculating system, a network communication system connecting module for sending and receiving data for the dynamic burst length calculating system, and a main memory unit for storing data of the data processing system for being processed by the CPU; the method comprising the steps of:
(1) when a data byte is written to a buffering memory unit, adding a write-in index address in a register by one; when a data byte is read out from the buffering memory unit, adding a read-out index address in the register by one; then proceeding to step (2);
(2) determining via a valid data calculating module whether the number of valid packet data in the buffering memory unit exceeds a preset main memory unit bus requesting threshold; if no, repeating step (2); if yes, determining via a main memory bus requesting module whether the packet data length exceeds preset capacity of packet data storage in the main memory unit, wherein if yes, a usage request is no longer sent to the main memory unit bus until the packet data finish, or if no, the main memory unit bus requesting module sends the usage request to the main memory unit bus; then proceeding to step (3);
(3) determining via a data length calculating module whether a sending data byte is the end of the packet data; if yes, calculating the length of this data byte; and
(4) having a burst length determining module compare the valid data byte length, the packet data length and the preset burst length in the buffering memory unit, and select the least one as a burst length value.

2. The method as claimed in claim 1, wherein the network communication system connecting module comprises:
the buffering memory unit controlled by the network communication system connecting module for data access of the buffering memory unit, and for providing a specific area for holding data to be sent or received;
the valid data calculating module controlled by the network communication system connecting module and for calculating the number of valid data in the buffering memory unit for the dynamic burst length calculating system;
the data length calculating module controlled by the network communication system connecting module, and for calculating the length of a data byte waiting to be transferred for the dynamic burst length calculating system;
the main memory unit bus requesting module controlled by the network communication system connecting module, and for determining whether the number of valid data in the buffering memory unit calculated by the valid data calculating module exceeds a preset value and for determining whether the data length exceeds preset capacity of data storage in the main memory unit, so as to send the usage request to the main memory unit bus in case of the data length not exceeding the preset capacity of data storage; and
the burst length determining module controlled by the network communication system connecting module, and for determining the length of burst data byte for the dynamic burst length calculating system.

3. The method as claimed in claim 1, wherein in step (3) if the sending data byte is not the end of the packet data, a data end index address is set to infinity.

4. The method as claimed in claim 1, in step (3), after the length of the sending data byte is calculated, further comprising a step of:
(3-1) adding a clock delay to the end of the packet data to distinguish different packets.

5. The method as claimed in claim 1, wherein the network communication system connecting module is a network interface card.

6. The method as claimed in claim 5, wherein the network communication system connecting module is connected to a network communication system.

7. The method as claimed in claim 6, wherein the network communication system is a Local Area Network (LAN).

8. The method as claimed in claim 7, wherein the LAN has Ethernet system architecture or Fast Ethernet system architecture.

9. A dynamic burst length calculating system for providing a data processing system through a dynamic burst length calculating method, so as to increase usage efficiency of a main memory unit bus and protect operation of the data processing system against effects from abnormal data; the dynamic burst length calculating system comprising:
a CPU (central processing unit) for providing interoperability between components and modules of the dynamic burst length calculating system;
a main memory unit bus for providing a hardware path for transferring data between the CPU and a plurality of memory units of the burst dynamic length calculating system;
a network communication system connecting module for sending and receiving data for the dynamic burst length calculating system; and
a main memory unit connected to the CPU and for storing data of the data processing system for being processed by the CPU.

10. The system as claimed in claim 9, wherein the network communication system connecting module comprises:
a buffering memory unit controlled by the network communication system connecting module for data access of the buffering memory unit, and for providing a specific area for holding data to be sent or received;
a valid data calculating module controlled by the network communication system connecting module and for calculating the number of valid data in the buffering memory unit for the dynamic burst length calculating system;
a data length calculating module controlled by the network communication system connecting module, and for calculating the length of a data byte waiting to be transferred for the dynamic burst length calculating system;
a main memory unit bus requesting module controlled by the network communication system connecting module, and for determining whether the number of valid data in the buffering memory unit calculated by the valid data calculating module exceeds a preset value and for determining whether the data length exceeds preset capacity of data storage in the main memory unit, so as to send the usage request to the main memory unit bus in case of the data length not exceeding the preset capacity of data storage; and
a burst length determining module controlled by the network communication system connecting module, and for determining the length of burst data byte for the dynamic burst length calculating system.

11. The system as claimed in claim 9, wherein the network communication system connecting module is a network interface card.

12. The system as claimed in claim 11, wherein the network communication system connecting module is connected to a network communication system.

13. The system as claimed in claim 12, wherein the network communication system is a Local Area Network (LAN).

14. The system as claimed in claim 13, wherein the LAN has Ethernet system architecture or Fast Ethernet system architecture.
